(19) United States
(12) Patent Application Publication
(10) Pub. No.: US 2007/0274237 A1
(43) Pub. Date: Nov. 29, 2007

(54) Method For Regulating The Output Power Of A Radio Access Point

(75) Inventors: Hui Li, Beijing (CN); Dan Yu, Beijing (CN); Peng Zhao, Grand-Lancy (CH)

Correspondence Address: STAAS & HALSEY LLP, SUITE 700, 1201 NEW YORK AVENUE, N.W., WASHINGTON, DC, 20005, US

(73) Assignee: Siemens Aktiengesellscheft, Munich (DE)

(21) Appl. No.: 10/589,894

(22) PCT Filed: Dec. 9, 2004
(86) PCT No.: PCT/EP04/53375

§ 371 Date: Apr. 20, 2007

(30) Foreign Application Priority Data
Feb. 18, 2004 (DE) 10 2004 007 975.7

(51) Int. Cl. H04B 7/005

(52) U.S. Cl. 370/278

(57) ABSTRACT

A radio communication system has a first and a second radio access point and a plurality of radio stations. The first radio access point broadcasts signals having an increasing output power. The first radio access point stops increasing the output power based on a message by at least one radio station located within the radio coverage range of the second radio access point. The message of the at least one radio station located within the radio coverage range of the second radio access point relates to at least one signal of the first radio access point and/or at least one signal of a radio station located within the radio coverage range of the first radio access point.

### CROSS REFERENCE TO RELATED APPLICATIONS

This application is based on and hereby claims priority to PCT Application No. PCT/EP2004/053375 filed on Dec. 9, 2004 and German Application No. 10 2004 007 975.7 filed Feb. 18, 2004, the contents of which are hereby incorporated by reference.

### BACKGROUND OF THE INVENTION

The invention relates to a method for communicating in a radio communication system which comprises a first and a second radio access point and a plurality of radio stations. The invention further relates to a radio access point, a network-side device and a radio station for communicating in such as radio communication system.

In radio communication systems, signals or messages, as applicable, such as for example signaling messages or messages with voice data, image data, video data, SMS (Short Message Service), MMS (Multimedia Messaging Service) or other data, are transmitted with the help of electromagnetic waves over a radio interface, between a sending and a receiving station. Depending on the specific embodiment of the radio communication system, the radio stations in this situation can be various types of subscriber-side radio stations, repeaters, or network-side radio access points. In a mobile radio communication system, at least some of the subscriber-side radio stations are mobile radio stations. The electromagnetic waves are broadcast with carrier frequencies which lie within the frequency band provided for the system concerned.

Mobile radio communication system are often structured as cellular systems, e.g. in accordance with the GSM (Global System for Mobile Communication) or UMTS (Universal Mobile Telecommunications System) standard, with a network infrastructure including, for example, of base stations, devices for checking and controlling the base stations and other network-side devices.

Apart from these cellular hierarchical radio networks, organized on a geographically wide (supra-local) basis, there are also radio communication systems with wireless local networks (WLANs, Wireless Local Area Networks), e.g. conforming to the HiperLAN, DECT, IEEE 802.11, Bluetooth and WATM standards. For WLANs, use is frequently made of the license-free frequency range around 2.4 GHz. The data transmissions are at rates of up to around 11 Mbit/s. Future WLANS can be operated in the 5 GHz range, for example, and achieve data transmission rates of over 50 Mbit/s. This means that WLAN subscribers will have available to them data transmission rates which are substantially higher than those offered by the third generation of mobile radio communication (e.g. UMTS). This will make it advantageous to access WLANs for high bit-rate connections for the transmission of large data volumes, in particular in conjunction with Internet accesses.

The size of the radio coverage areas handled by radio access points in radio communication systems depends on the transmission power used by the radio access points. The higher is the transmission power of a radio access point, the larger is the number of radio stations within the radio coverage area of the radio access point, and hence as the size of the radio coverage area increases so too does the maximum possible data throughput per radio access point, at least up to a certain upper limit. On the other hand, there is a danger that, as the transmission power of a radio access point increases, communications within the radio coverage area of other radio access points will be disrupted by interference.

### SUMMARY OF THE INVENTION

One possible object underlying the invention is to indicate an efficient method for regulating the transmission power of a radio access point. Further, it is to propose a radio access point, a radio station and a network-side device for carrying out the method.

With the method for communicating in a radio communication system, where the radio communication system includes a first and a second radio access point and a plurality of radio stations, the first radio access point broadcasts signals with an increasing transmission power. Further, the first radio access point terminates the increases in transmission power as a result of a message from one or more of the radio stations located within the radio coverage area of the second radio access point. Here, the message from the one or more radio station(s) located within the radio coverage area of the second radio access point relates to one or more signal(s) from the first radio access point and/or one or more signal(s) from a radio station located within the radio coverage area of the first radio access point.

The first and second radio access points can be, for example, base stations in a cellular radio communication system or access points in a WLAN. The multiplicity of radio stations can include, for example, radio stations on the subscriber side, in particular mobile ones, together with static or mobile repeaters. The first radio access point broadcasts signals with an increasing transmission power. Here, the transmission power may increase from one signal to the next, so that an individual signal is broadcast with a constant transmission power, and the increase in transmission power takes place between the signals. In doing this, it is not necessary that each of the signals broadcast with increasing transmission power has a higher transmission power then the preceding one, but instead successive signals can also have the same transmission power. However, it is also possible that the transmission power rises within individual signals.

The radio coverage area of a radio access point is that geographical area in which signals can be exchanged directly, i.e. with no forwarding of the signals by further radio stations, between radio stations and the radio access point. The size of the radio coverage area is determined by the transmission power used by the radio access point, so that an increase in the transmission power leads to an enlargement of the radio coverage area. The increase in transmission power is terminated by the first radio access point as a result of a message. This causality between the message and the termination of the increase in transmission power can be realized, for example, either by the first radio access point receiving the message directly from the transmitter of the message, or by the message being forwarded to the first radio access point, or even by the message evoking a reaction from another radio station or network-side device, as a result of which reaction the termination of the increase in transmission power is effected by the first radio station. The termination of the increase in transmission power can be temporary or permanent.

The message broadcast by the one or more radio station(s) located within the radio coverage area of the second radio access point relates to one or more signal(s) originating from the radio coverage area of the first radio access point. This can be realized, for example, by the message referring in explicit or coded form to a statement about the content of the signal, or alternatively by the message containing statements about the fact that the signal has been received and/or how, and/or about the nature of the signal and/or who sent the signal. Numerous items of data or combinations of data, which are associated directly or indirectly with the one or more signal(s) can thereby be contained in the message from the one or more radio station(s) located within the radio coverage area of the second radio access point.

The message from the one or more radio station(s) located within the radio coverage area of the second radio access point may include some content from, and/or a result of a measurement on, one or more signal(s) from the first radio access point and/or some content from, and/or a result from a measurement on, one or more signal(s) from a radio station located within the radio coverage area of the first radio access point. In the case of the signal content this might be, for example, a statement of the transmission power with which the signal is being broadcast, so that the message can inform the one or more radio station(s) located within the radio coverage area of the second radio access point about the transmission power of a signal from the radio coverage area of the first radio access point. The result of a measurement on a signal could, for example, include the result of a measurement relating to the received power and/or a signal-to-noise ratio.

It is advantageous if the first radio access point receives in each case from a plurality of radio stations a reply to the signals broadcast with the increasing transmission power by the first radio access point. The message from the one or more radio station(s) located within the radio coverage area of the second radio access point can then, for example, concern a reply signal of this type. Preferably, each radio station within the radio coverage area of the first radio access point will reply to each signal, broadcast from the first radio access point with increasing transmission power, which it receives. It is also possible for such a reply to be made only if the same radio station has not already replied to one of the earlier signals broadcast with increasing transmission power. In this way, the first radio access point can be informed about which radio stations are located within its transmission-power-dependent radio coverage area. From this it is then possible to draw conclusions as to whether a further increase in the transmission power is sensible. The radio stations which reply to the signals broadcast from the first radio access point with increasing transmission power use for their replies, in particular, the same transmission power as that used by the first radio access point for sending out the signal concerned.

The one or more radio station(s) located within the radio coverage area of the second radio access point may transmit the message if the received power of the one or more signal(s) from the first radio access point and/or from the radio station located within the radio coverage area of the first radio access point lies above a threshold value. In this case, the one or more radio station(s) located within the radio coverage area of the second radio access point checks whether it has received signals from the first radio access point and/or from radio stations in the radio coverage area of the first radio access point. If it detects reception of such a signal, it can measure the received power of the signal and compare it against a threshold value. This comparison with the threshold value determines whether the one or more radio station(s) located within the radio coverage area of the second radio access point transmits a message relating to the signal concerned.

For preference, the signals broadcast from the first radio access point with increasing transmission power contain items of data identifying the first radio access point and the transmission power used. The signals broadcast with increasing transmission power can include additional data apart from the transmission power and the items of identification data. If radio stations within the radio coverage area of the first radio access point reply to the signals broadcast with increasing transmission power, then it is advantageous if the transmission power used is repeated in the reply messages. In this case, a radio station which is located within the radio coverage area of the second radio access point is then in a position to extract directly, both from the signals broadcast with increasing transmission power by the first radio access point and also from the signals replying to these signals, the transmission power used.

In accordance with an advantageous embodiment, no messages may be transmitted by the second radio access point to the radio stations located within the radio coverage area of the second radio access point while the signal with increasing transmission power are being broadcast by the first radio access point. The purpose of this is to enable radio stations within the radio coverage area of the second radio access point to detect without interference whether they are receiving signals from the first radio access point, or from radio stations in the radio coverage area of the first radio access point, as applicable.

The one or more radio station(s) located within the radio coverage area of the second radio access point may transmit the message to a network-side device which differs from the first radio access point. This could be, for example, the second radio access point or even another network-side device.

It is of advantage if the one or more radio station(s) located within the radio coverage area of the second radio access point is instructed, by a message, to detect the reception of signals from the first radio access point and/or from radio stations located within the radio coverage area of the first radio access point. This instruction could be transmitted, for example, by the second radio access point or even by another network-side device, to the one or more radio station(s) located within the radio coverage area of the second radio access point. In particular, this could be the same network-side device as that to which the one or more radio station(s) located within the radio coverage area of the second radio access point send the message concerning the one or more signal(s) from the radio coverage area of the first radio access point.

The first radio access point may request by a message to a network-side device permission to broadcast signals with an increasing transmission power.

In accordance with another embodiment, a network-side device instructs the first radio access point, by a message, to broadcast the signals with increasing transmission power. This instruction can be issued, in particular, by the same network-side device as that from which the first radio access point has requested permission to broadcast signals of this type.

It is advantageous if the first radio access point is instructed by a network-side device, using a message, to terminate the increases in transmission power. This instruction can be issued, in particular, by the same network-side device as that which previously instructed the first radio access point to increase the transmission power. In this case, the instruction from the network-side device is transmitted as a response to the sending of the message, about the one or more signal(s) from the radio coverage area of the first radio access point, by the one or more radio station(s) located within the radio coverage area of the second radio access point.

The first radio access point is informed by a network-side device, using a message, of the transmission power which the first radio access point is to use after termination of the increases in the transmission power. This can be effected, in particular, in the same message as that which also gives an instruction to terminate the increases in transmission power.

In accordance with an advantageous embodiment, the first radio access point communicates with the radio stations located with the radio coverage area of the first radio access point, and the second radio access point with the radio stations located within the radio coverage area of the second radio access point, using a first radio frequency. This means that signals from the radio coverage area of the first radio access point interfere with the signals from the radio coverage area of the second radio access point, as a result of which the communications of radio stations with the first radio access point, and also the communications of radio stations with the second radio access point, are corrupted.

In an embodiment, messages are transmitted between radio stations, located outside the radio coverage areas of the first radio access point and the second radio access point, and the first radio access point and/or the second radio access point by forwarding of the messages by radio stations. In particular, for the purpose of forwarding messages between radio stations, a second radio frequency can be used.

The radio access point may have facilities for broadcasting signals with an increasing transmission power, and facilities for receiving a message sent by a radio station, located within the radio coverage area of another radio access point, relating to one or more signal(s) from the radio access point, or facilities for receiving a message transmitted by a network-side device with an instruction to terminate the increases in the transmission power. Further, the radio access point includes facilities for terminating the increases in transmission power as a result of the receipt of the message transmitted by the radio station located within the radio coverage area of the other radio access point, or as a result of the receipt of the message transmitted by the network-side device.

It is advantageous, in particular, if the facilities for receiving a message transmitted by a network-side device are designed in such a way that it is possible to receive a message, transmitted back by a network-side device on receipt of a message transmitted by a radio station located within the radio coverage area of another radio access point, relating to one or more signal(s) from the radio access point and/or one or more signal(s) from a radio station located within the radio coverage area of the radio access point, with the instruction to terminate the increases in transmission power.

The function described above, in terms of a network-side device for communicating in a radio communication system, is achieved by a network-side device. The network-side device has facilities for transmitting a message to a first radio access point with the instruction to broadcast signals with an increasing transmission power, and facilities for receiving a message, from a radio station located within the radio coverage area of a second radio access point, concerning one or more signal(s) from the first radio access point and/or one or more signal(s) from a radio station located within the radio coverage area of the first radio access point, together with facilities for transmitting a message, back to the first radio access point on receipt of the message from the radio station located within the radio coverage area of the second radio access point, with the instruction to terminate the increases in the transmission power.

The radio station has facilities for detecting the receipt of signals from a first radio access point which differs from the radio access point within whose radio coverage area the radio station is currently located, and/or of signals from radio stations located within the radio coverage area of the first radio access point. Further, the radio station includes facilities for determining the transmission power of detected signals and facilities for transmitting a message, concerning the transmission power of one or more detected signal(s) from the first radio access point and/or of one or more detected signal(s) from a radio station within the radio coverage area of the first radio access point, to a network-side device and/or to the first radio access point and/or to the radio access point within whose radio coverage area the radio station is currently located.

Both the radio access point and also the network-side device and the radio station are suitable, in particular, for performing the method, and this applies also to the embodiments and developments. For this purpose, they may have other suitable facilities.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1: a part of a radio communication system,

FIG. 2: a flow diagram of the method in accordance with an embodiment of the invention,

FIG. 3: in schematic form, the design of a radio access point in accordance with an embodiment of the invention

FIG. 4: in schematic form, the design of a base station in accordance with an embodiment of the invention

FIG. 5: in schematic form, the design of a mobile station in accordance with an embodiment of the invention

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The part of a radio communication system shown in FIG. 1 contains a base station BS in a cellular mobile radio communication system, such as for example a system conforming to the UMTS standard, and the four mobile stations MS1, MS2, MS3 and MS4, which can communicate with the base station via a radio interface of the cellular system. Apart from the base station BS, no further network-side devices of the cellular mobile radio communication system are shown, for the sake of clarity.

Located within the radio cell of the base station BS are the two radio access points AP-A and AP-B of a WLAN, which can communicate with the base station BS via a radio interface of the cellular system. The radio coverage area FZB of the radio access point AP-B is represented schematically by a circle around the radio access point AP-B. Two different sized radio access areas, FZA1 and FZA2, are shown for the radio access point AP-A—again in the form of circles. The mobile station MS3 is located within the radio coverage area FZB of the radio access point AP-B, within the smaller radio coverage area FZA1 of the radio access point AP-A is located the mobile station MS1, and the mobile stations MS1 and MS2 are within the larger radio coverage area FZA2 of the radio access point AP-A. The radio stations MS1, MS2 and MS3 communicate with the radio access points AP-A and AP-B via a WLAN interface, using a first frequency. By a connection, which is not shown in FIG. 1, from the two radio access points AP-A and AP-B to other communication systems, the mobile stations MS1, MS2 and MS3 are able, for example, to download data from the Internet.

The mobile station MS4 is located neither in the radio coverage area FZB of the radio access point AP-B nor in the radio coverage area FZA2 of the radio access point AP-A. However, it can communicate with the radio access point AP-A or AP-B, as appropriate, in that messages between the mobile station MS4 and the radio access point AP-A or AP-B respectively are forwarded by other mobile stations. This makes possible, for example, communication between the mobile station MS4 and the radio access point AP-B, in that the mobile station M3 forwards the messages concerned. The mobile stations MS1, MS2, MS3 and MS4 communicate with each other over the WLAN radio interface using a second frequency, which differs from the first frequency employed for communications between the radio access point AP-A or AP-B, as applicable, and the mobile station MS1, MS2, MS3 within the radio coverage areas FZB, or FZA1 or FZA2, respectively of the radio access points AP-B or AP-A.

In addition to the situation shown in FIG. 1, it is advantageous if the WLAN incorporates fixed radio stations which forward messages between the mobile stations MS1, MS2, MS3 and MS4 and the radio access points AP-A and AP-B, and thus act as so-called repeaters. Like the mobile stations MS1, MS2, MS3 and MS4, they use the WLAN's first frequency for communicating with the radio access points AP-A and AP-B, and the WLAN's second frequency for communications with the mobile stations MS1, MS2, MS3 and MS4.

The size of the radio coverage area of a radio access point grows as the radio access point's transmission power increases. As can be seen from FIG. 1 by a comparison of the two radio coverage areas FZA1 and FZA2 of the radio access point AP-A, the number of mobile stations which are within the radio coverage area of a radio access point increases with the transmission power of the radio access point concerned. If the radio access point AP-A uses a transmission power corresponding to the radio coverage area FZA1, direct communication is only possible between the radio access point AP-A and the mobile station MS1, while the transmission power corresponding to the radio coverage area FAZ2 enables direct communication between the radio access point AP-A and the two mobile stations MS1 and MS2. Furthermore, as the size of the radio coverage area of the radio access point AP-A increases, there are fewer mobile stations which communicate with each other using the second radio frequency, to forward messages from or to a radio access point. Thus, with the transmission power which corresponds to the radio coverage area FZA1, the mobile station MS2 must communicate with the mobile station MS1 on the second frequency used for forwarding purposes, while at the transmission power which corresponds to the radio coverage area FZA2 it is possible for the mobile station MS2 to communicate directly with the radio access point AP-A using the first radio frequency. Due to the fact that fewer mobile stations use the second radio frequency, the forwarding of messages using the second radio frequency can be effected more rapidly and more efficiently.

Thus, an increase in the transmission power of a radio access point effects an increase in the messages per unit of time which can be transmitted or received, as applicable, by the radio access point concerned, which corresponds to an increased data throughput. This applies at least insofar as the capacities of the radio access point concerned in terms of the available radio resources, such as for example timeslots and/or codes, are not used up. However, it should be noted that mobile stations of other radio access points use the same radio frequency for communicating with the other radio access points, so that interference can arise in the communications in the radio coverage areas of other radio access points if a radio access point increases its transmission power.

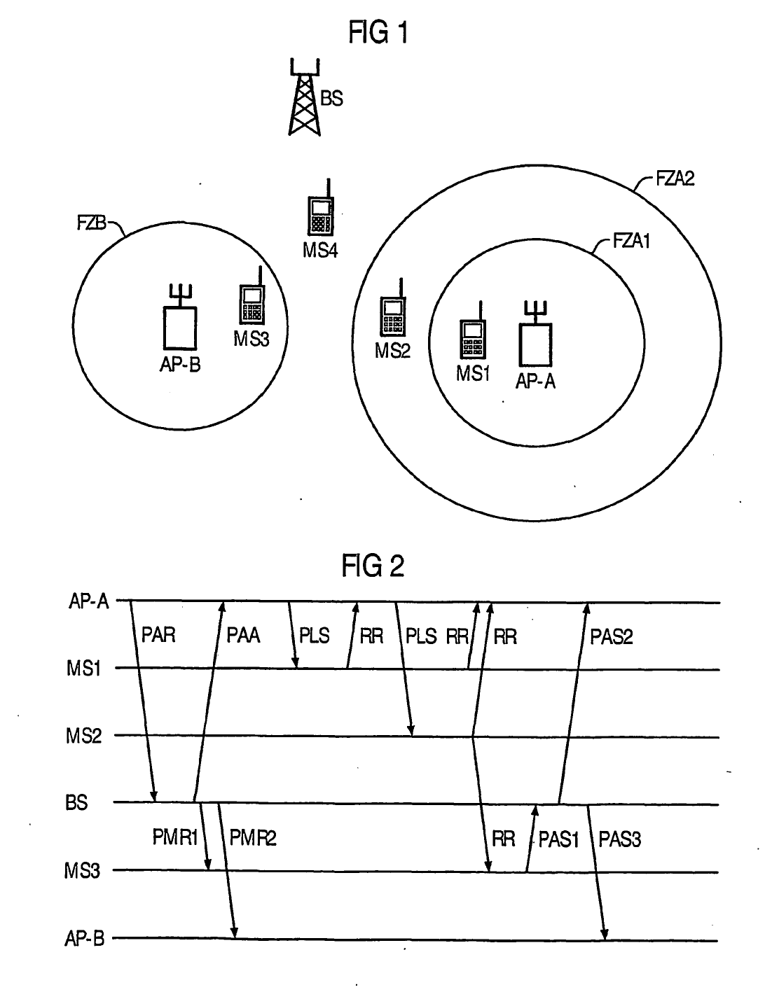

In what follows it is assumed that the radio access point AP-A wishes to increase the transmission power it is using. The prompt for this could be that the radio access point AP-A establishes that its radio cell resources are currently only partly being utilized, so that it would be in a position to communicate with a larger number of mobile stations. The method proceeds as shown in FIG. 2. At the beginning, the radio access point AP-A transmits a PAR message (Power Adjustment Request) to the base station BS, by which the base station BS is requested to issue permission to the radio access point AP-A to increase its own transmission power step by step. As the reply, the base station BS transmits a PAA message (Power Adjustment Allowance) to the radio access point AP-A, by which the radio access point AP-A is informed that a step by step increase in its transmission power is permitted. The base station BS sends to the mobile station MS3 a PMR1 message (Power Measurement Request), and to the radio access point AP-B a PMR2 message. The PMR1 message informs the mobile station MS3 that it may thereafter not send any messages to the radio access point AP-B, and should listen in on the first radio frequency. The radio access point AP-B also deduces from the PMR2 message that the sending of messages to radio stations within its radio coverage area is thereafter not permitted.

After it receives the PAA message, the radio access point AP-A starts sending a series of PLS messages, whereby each PLS message is broadcast with a higher transmission power than the previous PLS message. The PLS messages contain an item of data identifying the radio access point AP-A and details of the transmission power used for the particular PLS message concerned. All the mobile stations within the radio coverage area corresponding to the transmission power concerned of the radio access point AP-A reply to the PLS messages with an RR message (Resource Request). Thus, an RR message is sent in reply to the first PLS message by the mobile station MS1, and to the next PLS message by both mobile stations MS1 and MS2. In these RR messages the mobile stations repeat the transmission power, used by the radio access point AP-A for the PLS message concerned, which they take from the contents of the PLS message together with the item of data identifying the radio access point AP-A. Furthermore, the mobile stations specify in the RR messages the volume of the messages they wish to receive from the radio access point AP-A, or to send to it, as applicable. The specification of the required volume of radio resources enables the radio access point AP-A to decide whether the transmission power should be further increased, or whether its radio resources are utilized so that a further enlargement of the radio coverage area is not sensible.

Because of the proximity of the mobile station MS1 to the radio access point AP-A, mobile station MS1 uses a lower transmission power to send its reply RR, so that the RR message from the mobile station MS1 is not received by the mobile station MS3. On the other hand, the RR message sent by the mobile station MS2 is received not only by the radio access point AP-A but also by the mobile station MS3, which checks whether the received signal level for the RR message exceeds a certain threshold value. If it does, the mobile station MS3 extracts, from the RR message from mobile station MS2, the transmission power which the radio access point AP-A used for its second PLS message, and the radio access point to which the RR message it received was sent. Using a PAS1 message (Power Adjustment Stop), the mobile station MS3 transmits to the base station BS the information that the received signal level for the first WLAN frequency in the radio coverage area of the radio access point AP-B, detected as a result of the communication in the radio coverage area of the radio access point AP-A, has exceeded the threshold value, and how high the corresponding transmission power was from the radio access point AP-A or the mobile station MS2, whichever applies, which exceeded the threshold value in terms of the received signal level.

Thereupon, the base station BS transmits to the radio access point AP-A a PAS2 message, by which the radio access point AP-A is informed that the radio access point AP-A may not increase its transmission power any further, and thus may not send any further PLS messages. The radio access point AP-A also learns from the PAS2 message what transmission power it may use thereafter. This will preferably be the highest transmission power which did not prompt any PAS1 message from mobile stations within the radio coverage area of the radio access point AP-B. As this at least provisionally concludes the method for regulating the transmission power of the radio access point AP-A, the radio access point AP-B is informed by the base station BS in the message PAS3 that it may thereafter once again send messages to radio stations within its radio coverage area.

FIG. 3 shows in schematic form the design of the radio access point AP-A. Using the facilities RECEIVE_AP, which include a receiving antenna, the radio access point AP-B receives the messages PAA and PAS2 from the base station, by which it is informed, as applicable, whether or not an increase in the transmission power is permitted, or whether the increases in transmission power must be terminated, or what transmission power is to be used. Alternatively or additionally, messages could also be received through the RECEIVE_AP facilities from mobile stations in the radio coverage areas of other radio access points, informing the radio access point AP-A about signals from its radio coverage area which the mobile station concerned has received. The RECEIVE_AP facilities pass on the data received to the EVALUATE facilities, which are used to decide how the transmission power should be set in future. The EVALUATE facilities influence the CONTROL facilities, which control the adjustment of the transmission power and which, for the purpose of broadcasting signals or messages with the appropriate transmission power, are connected to the transmission antenna A.

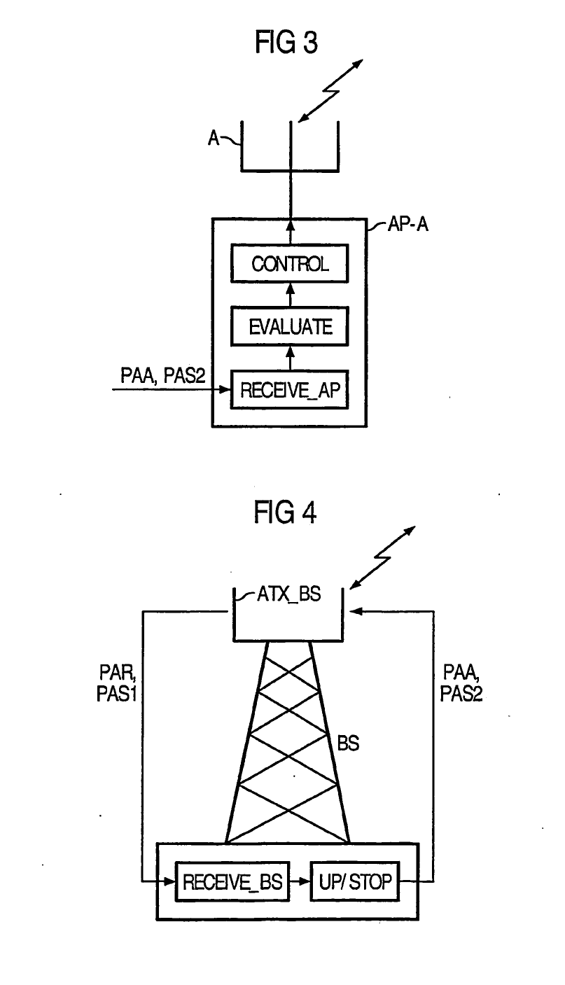

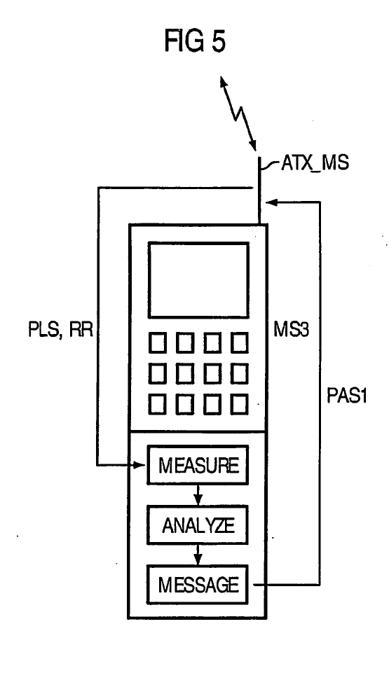

FIG. 4 shows in schematic form the design of a base station BS. Using the RECEIVE_BS facilities, which are connected to a receive and transmit antenna ATX-BS, the base station BS receives PAR requests from radio access points, for approval of increases in their transmission power, together with PAS1 messages from mobile stations with requests to terminate the increases in transmission power by the radio access points. The data received about the transmission power of radio access points is passed on to the UP/STOP facilities, with which the base station BS decides, as applicable, what transmission power the radio access points should use or whether an increase in the transmission power concerned is permitted or should be terminated. Messages with a corresponding content, such as the PAA and PAS2 messages described above, are broadcast to the appropriate radio access points by the base station BS via the receive and transmit antenna ATX_BS, to which the UP/STOP facilities are connected.

FIG. 5 shows in schematic form the design of a mobile station MS3 i. Through the receive and transmit antenna ATX-MS, the mobile station MS3 receives, from base stations, radio access points and other mobile stations, signals such as for example the PLS and RR messages described above. Using the MEASURE facilities, it detects whether a message has been received, and if so what is the received signal level for the message concerned. By using the ANALYZE facilities to investigate the content of PLS and RR messages which have been detected, the mobile station MS3 can determine the transmission power with which the message concerned was broadcast. In addition, or alternatively, the ANALYZE facilities can also make calculations to determine the transmission power of signals which have been received. The results produced by the MEASURE and ANALYZE facilities go into the MESSAGE facilities, which generate messages such as for example the PAS1 message described above. The MESSAGE facilities pass on the message to the receive and transmit antenna ATX_MS, which transmits it to base stations, radio access points or mobile stations.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-18. (canceled)

19. A method for communicating in a radio communication system which includes a first radio access point, a second radio access point and a plurality of radio stations, each of the first and second radio access points having a respective coverage area, comprising:
broadcasting broadcast signals from the first radio access point with increasing transmission power; and
terminating increases in the transmission power as a result of a stop message from a radio station located within the radio coverage area of the second radio access point, the stop message relating to:
a broadcast signal from the first radio access point received at the radio station located within the radio coverage area of the second access point, and/or
a response signal to the broadcast signal, which response signal was issued by a radio station located within the radio coverage area of the first radio access point and received at the radio station located within the radio coverage area of the second access point.

20. The method in accordance with claim 19, wherein the stop message describes a content of and/or a result of a measurement of:
the broadcast signal from the first radio access point, and/or
the response signal from the radio station located within the radio coverage area of the first radio access point.

21. The method in accordance with claim 19, wherein the first radio access point receives a response signal from each radio station located within the radio coverage area of the first radio access point that received a broadcast signal.

22. The method in accordance with claim 19, wherein the radio station located within the radio coverage area of the second radio access point sends the stop message if the received power of the broadcast signal from the first radio access point or the response signal from radio station located within the radio coverage area of the first radio access point exceeds a threshold value.

23. The method in accordance with claim 19, wherein each broadcast signal identifies the first radio access point and the transmission power used for the broadcast signal.

24. The method in accordance with claim 19, wherein during the broadcasting of the broadcast signals, no messages are transmitted by the second radio access point to radio stations located within the radio coverage area of the second radio access point.

25. The method in accordance with claim 19, wherein the radio station located within the radio coverage area of the second radio access point transmits the stop message to a network-side device which differs from the first radio access point.

26. The method in accordance with claim 19, wherein the radio station located within the radio coverage area of the second radio access point is instructed by a message to detect receipt of broadcast signals from the first radio access point and/or response from radio stations located within the radio coverage area of the first radio access point.

27. The method in accordance with claim 19, wherein prior to broadcasting broadcast signals, the first radio access point uses a message to request from a network-side device permission to broadcast the broadcast signals.

28. The method in accordance with claim 19, wherein a network-side device instructs the first radio access point via a message to broadcast the broadcast signals.

29. The method in accordance with claim 19, wherein the first radio access point learns of the stop signal when a network-side device instructs the first radio access point via a message requesting the first access point to terminate the increases in transmission power.

30. The method in accordance with claim 19, wherein a network-side device informs the first radio access point, via a message, what transmission power the first radio access point should use after terminating the increases in transmission power.

31. The method in accordance with claim 19, wherein
a first radio frequency is used by the first radio access point to communicate with the radio stations located within the radio coverage area of the first radio access point, and
the first radio frequency is used by the second radio access point to communicate with the radio stations located within the radio coverage area of the second radio access point.

32. The method in accordance with claim 19, wherein if a distant radio station is located outside both the coverage area of the first radio access point and the coverage area of the second radio access point, then the distant radio station transmits messages to another radio station which forwards the messages.

33. The method in accordance with claim 32, wherein a second radio frequency is used for the purpose of forwarding messages between radio stations.

34. The method in accordance with claim 33, wherein
a first radio frequency different from the second radio frequency is used by the first radio access point to communicate with the radio stations located within the radio coverage area of the first radio access point, and
the first radio frequency is used by the second radio access point to communicate with the radio stations located within the radio coverage area of the second radio access point.

35. A primary radio access point for communicating in a radio communication system which includes the primary radio access point, a secondary radio access point and a plurality of radio stations, each of the primary and secondary radio access points having a respective coverage area, comprising:
a transmitter to broadcast signals with increasing transmission power,
a receiver to receive:
a stop message transmitted by a radio station located within the radio coverage area of the secondary radio access point, the stop relating to a broadcast signal, or
a message transmitted by a network-side device with an instruction to terminate increases in the transmission power; and
an evaluation unit to terminate the increases in the transmission power as a result of receiving the stop message, or as a result receiving the message transmitted by the network-side device.

36. A network-side device for communicating in a radio communication system which includes a first radio access point, a second radio access point and a plurality of radio stations, each of the first and second radio access points having a respective coverage area, comprising:
a first transmission unit to transmit a message to the first radio access point to broadcast signals with increasing transmission power;
a receiver to receive a stop message from a radio station located within the radio coverage area of the second radio access point, the stop message relating to:
a broadcast signal from the first radio access point received at the radio station located within the radio coverage area of the second access point, and/or
a response signal to the broadcast signal, which response signal was issued by a radio station located within the radio coverage area of the first radio access point and received at the radio station located within the radio coverage area of the second radio access point; and
a second transmission unit to transmit a message, on receipt of the stop message, back to the first radio access point instructing the first radio access point to terminate the increases in transmission power.

37. A radio station for communicating in a radio communication system which includes a first radio access point, a second radio access point and a plurality of radio stations, each of the first and second radio access points having a respective coverage area, the radio station being located within the coverage area of the second radio access point, comprising:
a detector to detect receipt of a broadcast signal from the first radio access point, and/or to detect a response signal to the broadcast signal, which response signal was issued by a radio station located within the radio coverage area of the first radio access point and received at the radio station located within the radio coverage area of the second access point;
a unit to determine a transmission power of the signal detected by the detector;
a transmitter to transmit a message concerning the transmission power of the signal detected by the detector, to a network-side device and/or to the second radio access point.
